(19) United States
(12) Patent Application Publication
(10) Pub. No.: US 2026/0084305 A1
(43) Pub. Date: Mar. 26, 2026

(54) METHOD FOR PLANNING AND CONTROLLING HUMANOID BEHAVIOR OF ROBOT FOR CLOSE PHYSICAL INTERACTION

(71) Applicant: TONGJI UNIVERSITY, Shanghai (CN)

(72) Inventors: Bin HE, Shanghai (CN); Yanmin ZHOU, Shanghai (CN); Zheng YAN, Shanghai (CN); Chengjin WANG, Shanghai (CN); Zhipeng WANG, Shanghai (CN)

(73) Assignee: TONGJI UNIVERSITY, Shanghai (CN)

(21) Appl. No.: 19/333,388

(22) Filed: Sep. 19, 2025

(30) Foreign Application Priority Data
Sep. 20, 2024 (CN) 2024113164018

(51) Int. Cl. B25J 9/16

(52) U.S. Cl. CPC B25J 9/1664; B25J 9/163; B25J 9/1692

(57) ABSTRACT

The present disclosure relates to a method for planning and controlling a humanoid behavior of a robot for close physical interactions, which includes: step S1, acquiring demonstration data of close interactions between the robot and human beings through motion capture; step S2, obtaining a plurality of human behavior pattern categories based on the demonstration data by using prior knowledge and clustering analysis; step S3, segmenting and calibrating the demonstration data based on the plurality of human behavior pattern categories to obtain a plurality of groups of movement primitive sequences including human behavior pattern labels, constructing a hierarchical directed graph, and obtaining a robot behavior planner through training; and step S4, constructing a dynamically consistent mapping model between a target trajectory and an action space, and realizing the planning and control of the humanoid behaviors of the robot based on the dynamically consistent mapping model and the robot behavior planner.

### FIELD OF THE INVENTION

The present disclosure relates to the technical field of robots, in particular to a method for planning and controlling a humanoid behavior of a robot for close physical interactions.

### BACKGROUND OF THE INVENTION

With development of robot and artificial intelligence technology, the machines have gradually developed from an automation system based on pre-programming to an intelligent system with perception, which has ability to adjust behaviors according to environmental perception and even to predict human intentions. However, their ability to deal with emergencies in an open dynamic environment and close-cooperation scenarios is still lacking, and their autonomy and efficiency still need to be improved. Therefore, there is an urgent need in the future for embodied intelligence to make independent decisions and perform physical interaction tasks like human beings, which is also one of development directions foreseen at the beginning of the birth of artificial intelligence. An urgent problem of the embodied intelligence is how the robot feels, understands and infers embodied physical interactions of itself with the world. For example, in the field of home service, it is of great significance for a service robot to understand its own behaviors to ensure execution efficiency and service quality when it faces close physical interaction tasks such as arms hugging and dexterous grasping. However, due to difference of cross-modal information and difficulty of self-supervised learning, it is very challenging for the robot to understand its own behaviors and predict resulting perception consequences.

In view of the problem of robot behavior understanding and prediction of the perception consequences, a cognitive development robot method has gradually become a mainstream of embodied intelligence researches. Currently, researches on the cognitive development robot method in the field of behavior understanding is still in its infancy. In addition, the embodied intelligence requires the robot to have ability of autonomous development and fast learning to be adapted to dynamic uncertainty of the environment in real time. Therefore, it has become a problem to be solved in this field to reduce dependence of methods on a large number of data, enhance ability of autonomous development while improving task universality in robot behavior understanding and prediction of perception consequences.

### SUMMARY OF THE INVENTION

An object of the present disclosure is to provide a method for planning and controlling a humanoid behavior of a robot for close physical interactions in order to overcome defects existing in related art, so as to realize close physical interactions between human being and computers.

The object of the present disclosure can be achieved by following technical schemes.

In an aspect of the present disclosure, a method for planning and controlling a humanoid behavior of a robot for close physical interactions is provided, which includes:
step S1, acquiring demonstration data of close interactions between the robot and human beings through motion capture;
step S2, obtaining a plurality of human behavior pattern categories based on the demonstration data by using prior knowledge and clustering analysis;
step S3, segmenting and calibrating the demonstration data based on the plurality of human behavior pattern categories to obtain a plurality of groups of movement primitive sequences including human behavior pattern labels, constructing a hierarchical directed graph, and obtaining a robot behavior planner through training; and
step S4, constructing a dynamically consistent mapping model between a target trajectory and an action space, and realizing the planning and control of the humanoid behavior of the robot based on the dynamically consistent mapping model and the robot behavior planner.

As a preferred technical scheme, the obtaining the plurality of human behavior pattern categories based on the demonstration data by using the prior knowledge and the clustering analysis in the step S2 includes following steps:
step S201, obtaining a clustering result based on the demonstration data through density-based clustering analysis; and
step S202: obtaining key attributes in human close physical interaction behaviors based on the clustering result and the prior knowledge obtained in advance, and constructing the plurality of human behavior pattern categories.

As a preferred technical scheme, the step S202 includes:
step S2021, obtaining the prior knowledge based on pre-acquired interdisciplinary literature;
step S2022, obtaining the key attributes in the human close physical interaction behavior based on the prior knowledge and the clustering result, the key attributes including tightness, hugging style, and bimanual cooperation style; and
step S2023, dividing hugging actions into the plurality of human behavior pattern categories based on the key attributes according to whether a chest is in contact, an extension direction of an upper arm and a stress direction of two arms.

As a preferred technical scheme, the segmenting and calibrating the demonstration data based on the plurality of human behavior pattern categories in the step S3 includes:
constructing a respective movement primitive for each of the plurality of human behavior pattern categories and segmenting and calibrating the demonstration data to obtain the plurality of groups of movement primitive sequences including human behavior pattern labels.

As a preferred technical scheme, in the step S3, the hierarchical directed graph is constructed as follows:

$$G = ( S , V , R , P , σ )$$

in which S represents a target hugging action, V is an AND node or an OR node in the directed graph, R represents a top-down production rule from a parent node α to its child node β, P represents a probability associated with each production rule, and σ is a behavior planning sequence defined by grammar.

As a preferred technical scheme, the obtaining the robot behavior planner through the training in the step S3 includes:
learning an association between a movement primitive space and a state space using a Q-learning rule in a temporal-difference manner by using a joint space of the two arms as a state space and with probability P between respective nodes as a learning object, and recovering a grammatical structure by automatic structural distillation according to posterior probability, so as to obtain the robot behavior planner.

As a preferred technical scheme, the realizing the planning and control of the humanoid behavior of the robot based on the dynamically consistent mapping model and the robot behavior planner in the step S4 includes:
generating a next movement primitive needed to complete the target hugging action by using the robot behavior planner for different joint states, and performing the target hugging action by using a respective mapping model.

As a preferred technical scheme, the demonstration data includes capture data for hugging behaviors and actions of multiple roles of participants in multiple age groups in multiple preset scenes, the multiple preset scenes including social occasions, intimate relationships, emotional expression and motor functions, and the roles include an initiator and a receiver.

In another aspect of the present disclosure, an electronic device is provided, which includes one or more processors and a memory with one or more programs stored therein, and the one or more programs include instructions for executing the method for planning and controlling the humanoid behavior of the robot for close physical interactions described above.

In another aspect of the present disclosure, a computer-readable storage medium is provided, which includes one or more programs for execution by one or more processors of an electronic device, and the one or more programs include instructions for executing the method for planning and controlling the humanoid behavior of the robot for close physical interactions described above.

Compared with related art, the present disclosure at least provides following beneficial effects.

(1) Full-process coverage of realization of robot humanoid behaviors: in the present disclosure, a whole process of robot behavior learning, planning and execution can be realized based on human behavior demonstration for close physical interactions between human beings and machines, so as to meet a requirement of rapid and dynamic human-machine collaboration.

(2) Accurate behavior modeling: in the present disclosure, human demonstration and the prior knowledge are combined to distinguish different behavior patterns, and by adopting a clear and distinguishable interaction pattern classification method, close physical interaction behaviors of human beings are modeled as a movement primitive sequence, which facilitates simplifying of planning and execution of the robot behaviors.

(3) Effective improving of interpretability of the robot behaviors: in the present disclosure, the human movement primitive sequence planner can be learned based on a hierarchical directed graph method, and the robot movement primitive control method derived from human behavior pattern analysis is further combined, effectively improving interpretability, anthropomorphism and adaptability of the robot behaviors, and effectively alleviating contradiction between planning interpretability and execution performance of the robot interaction behaviors.

### BRIEF DESCRIPTION OF DRAWINGS

FIG. 1 is a flowchart of a method for planning and controlling a humanoid behavior of a robot for close physical interactions according to an embodiment;

FIG. 2 is a schematic diagram of an analysis approach of human behavior patterns according to an embodiment;

FIG. 3 is a schematic diagram of a directed-graph planner and a movement primitive according to an embodiment; and

FIG. 4 is a schematic diagram of a full-process framework for planning and executing a humanoid behavior of a robot for close physical interactions according to an embodiment.

### DETAILED DESCRIPTION

The technical schemes in the embodiments of the present disclosure will be clearly and completely described in the following with reference to attached drawings. Obviously, the described embodiments are only a part of the embodiments of the present disclosure, but not all of them. On a basis of the embodiments in this present disclosure, all other embodiments obtained by the ordinary skilled in the art without any creative effort should be within the protection scope of this present disclosure.

### Embodiment 1

This embodiment provides a method for planning and controlling a humanoid behavior of a robot for close physical interactions, particularly with reference to human behavior demonstrations. The close physical interactions in this embodiment mainly refers to a dyadic hug, and only focuses on operations of two arms. Based on human demonstration data and prior knowledge, this method analyzes categories of human hug patterns, effectively guides calibration of human behaviors, realizes grammar parsing of planning of robot hug behaviors, and guides setting and learning of dynamic movement primitives (DMP), so as to improve anthropomorphism and interpretability of behavior planning and execution, and make the behaviors effectively adapt to complex external interaction conditions.

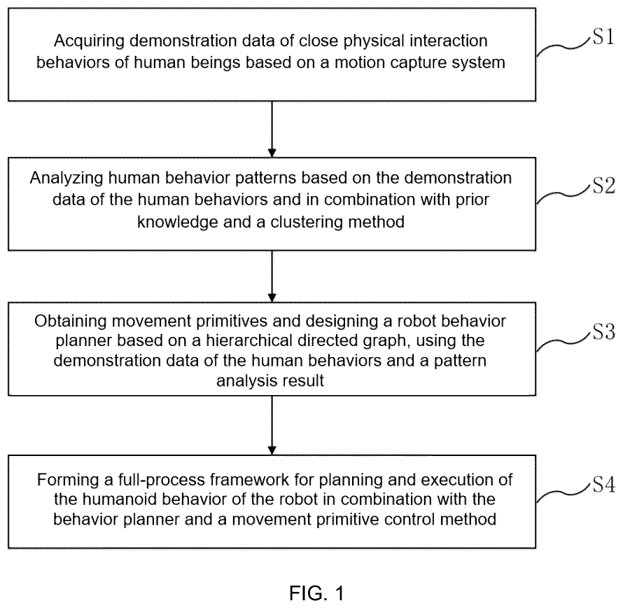

As shown in FIG. 1, the method includes following steps S1 to S4.

Step S1, demonstration data of close physical interaction behaviors of human beings is acquired based on a motion capture system.

Specifically, an accurate and effective motion capture environment is built indoors for collection of demonstration data of human hugs. External measurement devices in the environment includes optical sensors, including 20 infrared cameras of 60 fps, which are evenly arranged on a ceiling of a space of 6.5 m×6.5 m×2.5 m and located at four sides of a square (with five cameras on each side). For sake of data accuracy, the space is kept isolated and quiet. In each experiment, two participants wore motion capture suits with 53 marks and 17 inertial units and were instructed to perform free hugging. Real-time observation data of angle and velocity of each joint are calculated and obtained by combining inertial sensing and optical sensing data.

In order to ensure quality and comprehensiveness of the human demonstration data, a participant group consists of six people who span middle-aged and elderly age groups, and hug demonstration experiments are made between each participant and other participants to form 15 unique pairs. The experiments involve four preset scenarios (social occasion, intimate relationships, emotional expression and moving function) and two participating roles (initiator and receiver), covering all possible human behaviors in hugs as far as possible. In this embodiment, it is demonstrated five times under each experimental condition, and a total of 15×2×4×5=600 groups of samples are obtained.

Step S2, human behavior patterns are analyzed based on the demonstration data of the human behaviors and in combination with prior knowledge and a clustering method.

This step specifically includes following sub-steps S201 and S202.

Step S201, behavior patterns appearing in the demonstration data of the close physical interaction behaviors of the human beings are preliminarily analyzed based on a clustering analysis algorithm.

Specifically, density-based spatial clustering of applications with noise (DBSCAN) is used to process the demonstration data of the human hugs, with a scanning radius (eps) being set to 1 and a minimum number of inclusion points (minPts) being set to 3. A resulting clustering result is collated, samples in each category are observed and analyzed, common characteristics between the samples are explored, with focus on emerging physical properties of the two arms.

Step S202, emerging key attributes in the close physical interaction behaviors of the human beings are extracted in combination with relevant literature in the fields of robotics, psychology, behavioral science, etc., and the human behavior pattern categories are obtained. Specifically:

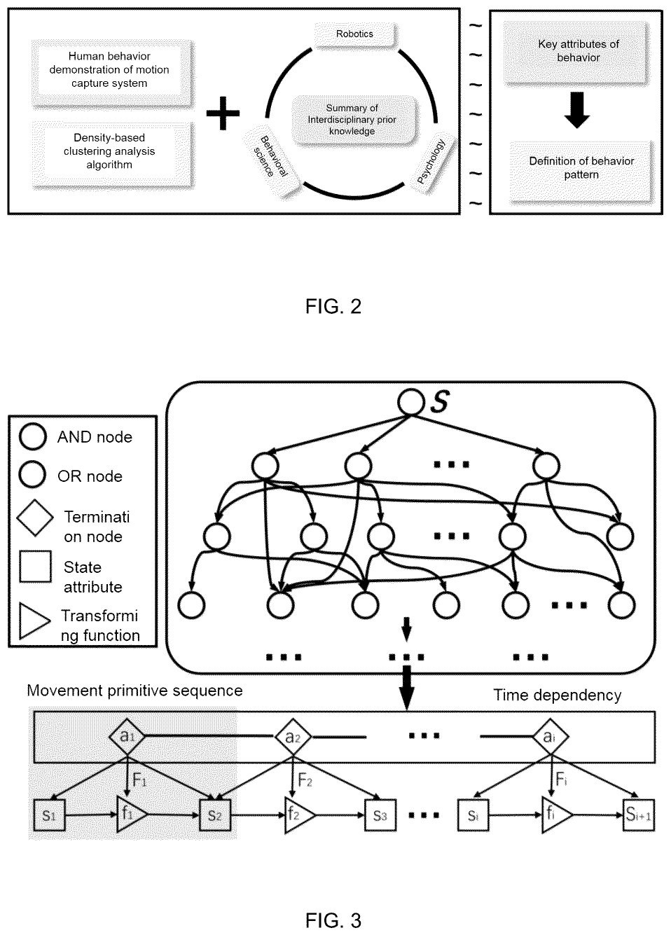

In this embodiment, as shown in FIG. 2, an idea of classifying human hug behavior patterns is as follows: according to analysis of the human demonstration data and summary of interdisciplinary literature, three key attributes are extracted to further form category definition of human hug behaviors.

S2021, prior knowledge of existing researches, which includes all considered key attributes and distinguished pattern categories, are summarized based on research literature of human hugging behavior analysis in the fields of hugging robot, hugging psychology and behavioral science.

S2022, the prior knowledge is combined with a sample analysis result of the clustering result in the step S201, and the emerging key attributes of human hugging behaviors, including tightness, hugging and cooperation style of the two arms, are summarized and proposed;

S2023, respective classification rules are designed in sequence according to the above three emerging key attributes in order to guide and define the human behavior pattern categories. Specifically, the classification rules involve (1) whether a chest is in contact; (2) an extension direction of an upper arm; (3) a stress direction of the two arms. According to these rules, hugs are defined in 16 categories.

Step S3, movement primitives are obtained and a robot behavior planner based on a hierarchical directed graph is designed using the demonstration data of the human behaviors and a pattern analysis result.

Specifically, this step includes following sub-steps S301 and S302.

Step S301, the demonstration data of the human behaviors is calibrated and segmented according to the human behavior pattern categories, so as to obtain respective movement primitives.

Specifically, for 16 human hug pattern categories, 16 corresponding movement primitives are set. According to definition of the 16 human hug pattern categories, 600 groups of human demonstration samples are segmented and calibrated, and 600 groups of movement primitive sequences with labels of the human behavior pattern categories are obtained, and a number of human demonstration samples are obtained for each of movement primitives.

Step S302, planning of the movement primitive sequences is learned based on the calibrated demonstration data and using a hierarchical directed graph method.

Specifically, in this embodiment, the movement primitive sequences are processed into a hierarchical directed graph (Temporal And-Or Graph, T-AOG) data structure, and then probability between respective nodes of the hierarchical directed graph is learned according to the calibrated movement primitive sequences with action labels, and behavior planning grammar is parsed. That is, a grammar parsing device can be described in a following sequence:

$$G = ( S , V , R , P , σ ) \qquad ( 1 )$$

in which S represents a specific target action, that is, hug, V represents an AND node or an OR node in the hierarchical directed graph, R represents a top-down production rule from a parent node α to its child node β, and P represents a probability associated with each production rule (that is, probability from an upper node to a lower node), and a learning process is transformed into a process of learning probability P between respective nodes. σ is a behavior planning sequence defined by grammar, that is, the set of all valid sentences that can be generated by the grammar.

As shown in FIG. 3, an end (a termination node) of the directed graph represents all types of movement primitives, representing a process of transforming a body from one state St to another state St+1 through a transforming function (respective joint velocities) f. Association between a movement primitive space and a state space is learned using a Q-learning rule in a temporal-difference manner by using a joint space of the two arms as a state space, and a grammatical structure is recovered by automatic structural distillation (ADIOS) according to posterior probability. This is shown in a following formula (2).

$$Q ( St , ai ) = ( 1 - α ) \cdot Q ( St , ai ) + α \cdot [ r ( St , ai ) + γ \cdot max {a}^{′} Q ( St , {a}^{′} ) ] \qquad ( 2 )$$

in which ai represents a current action, a′ represents a next action that may be taken, α represents a learning rate, r represents a reward function of the action, and γ represents a current value (discount factor) of a future reward.

To sum up, a behavior planner based on a form of the directed graph is obtained through the step S302.

Step S4, a full-process framework for planning and execution of the humanoid behavior of the robot is formed in combination with the behavior planner and a control method based on the movement primitives.

Specifically, this step includes following sub-steps S401 and S402.

Step S401, a dynamically consistent mapping model between a target trajectory and the action space is learned for the movement primitive sequences obtained in the step S301. Specifically, in this embodiment, a dynamic and consistent mapping model between a joint angle trajectory and a control command is learned for 16 hug behavior pattern categories.

Step S402, a mapping model for each of the movement primitives is combined with the movement primitive planner to realize the planning and execution of the humanoid behavior of the robot. Specifically, this step includes following sub-steps S4021 to S4023.

Step S4021, a next movement primitive needed to complete the target hugging action is generated by using the behavior planner for different joint states.

Step S4022, the mapping model of the movement primitive generated in S4021 is executed

Step S4023, the steps S4021 and S4022 are repeatedly executed until the target task is achieved, so as to form a whole process of planning and execution of the humanoid behavior of the robot.

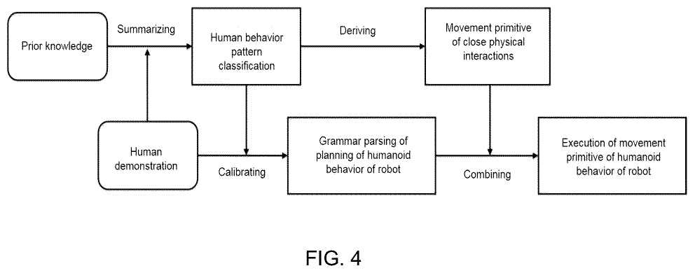

FIG. 4 is a schematic diagram of a full-process framework for planning and execution of a humanoid behavior of a robot for close physical interactions according to an embodiment. Combined with the human demonstration under the motion capture system, planning and execution of various tasks in the field of close physical interactions can be realized, which has good task performance and broad application prospects.

### Embodiment 2

An electronic device is provided in this embodiment, which includes one or more processors and a memory with one or more programs stored therein, and the one or more programs include instructions for executing the method for planning and controlling the humanoid behavior of the robot for close physical interactions as described in Embodiment 1.

Specifically, the electronic device may include a memory, a processor, and a program stored in the memory, and the processor implements the aforementioned method when executing the program. The processor of the device includes a central processing unit (CPU), which can perform various appropriate actions and processes according to a computer program instruction stored in a read-only memory (ROM) or a computer program instruction loaded from a storage unit into a random-access memory (RAM). Various programs and data required for operations of the device can also be stored in the RAM.

The CPU, ROM and RAM are connected with each other through a bus. An Input/output (I/O) interface is also connected to the bus. A number of components in the device are connected to the I/O interface, including an input unit, such as a keyboard or a mouse; an output unit such as various types of displays or speakers; a storage unit, such as a magnetic disk or optical disk; and a communication unit such as a network card, a modem or a wireless communication transceiver.

The communication unit allows the device to exchange information/data with other devices through a computer network such as the Internet and/or various telecommunication networks. The processing unit performs various methods and processes described above, such as the aforementioned steps. For example, in some embodiments, the aforementioned steps can be implemented as a computer software program tangibly embodied in a machine-readable medium, such as the storage unit. In some embodiments, part or all of the computer program can be loaded into and/or installed on the device via the ROM and/or the communication unit. When the computer program is loaded into the RAM and executed by the CPU, one or more steps described above can be performed.

Alternatively, in other embodiments, the CPU may be configured to perform the aforementioned method by any other suitable means (for example, by means of firmware). The functions described above may be at least partially performed by one or more hardware logic components. For example, without limitation, exemplary types of hardware logic components that can be used include: field programmable gate array (FPGA), application specific integrated circuit (ASIC), application specific standard product (ASSP), system on chip (SOC), complex programmable logic device (CPLD) and the like.

### Embodiment 3

A computer-readable storage medium is provided in this embodiment, which includes one or more programs for execution by one or more processors of an electronic device, and the one or more programs include instructions for executing the method for planning and controlling the humanoid behavior of the robot for close physical interactions as described in Embodiment 1.

Specifically, for the storage medium provided in this embodiment, a program is stored thereon, and when the program is executed, the aforementioned method is implemented. The program code for implementing the method of the present disclosure can be written in any combination of one or more programming languages. These program codes may be provided to processors or controllers of the general-purpose computers, the special-purpose computers or other programmable data processing devices, so that when executed by the processors or controllers, the program codes cause the functions/operations specified in the flowcharts and/or block diagrams to be implemented. The program codes can be completely executed on a machine, partially executed on the machine, partially executed on the machine as an independent software package and partially executed on a remote machine, or completely executed on a remote machine or server.

In the context of this present disclosure, a computer-readable medium can be a tangible medium that can contain or store a program for use by or in connection with an instruction execution system, apparatus or device. The machine-readable medium may be a machine-readable signal medium or a machine-readable storage medium. The machine-readable media can include, but are not limited to, electronic, magnetic, optical, electromagnetic, infrared, or semiconductor systems, devices or devices, or any suitable combination of the above. More specific examples of the machine-readable storage media can include an electrical connection based on one or more wires, a portable computer disk, a hard disk, a random-access memory (RAM), read-only memory (ROM), an erasable programmable read-only memory (EPROM or flash memory), an optical fiber, a compact disk read-only memory (CD-ROM), an optical storage device, a magnetic storage device, or any suitable combination of the above.

The above description is only specific embodiments of the present disclosure, but the protection scope of the present disclosure is not limited to this, and various equivalent modifications or substitutions within the technical scope disclosed by the present disclosure may occur to those skilled in the art and should be encompassed within the protection scope of the present disclosure. Therefore, the protection scope of the present disclosure shall be subject to the protection scope of the claims.

1. A method for planning and controlling a humanoid behavior of a robot for close physical interactions, comprising:
step S1, acquiring demonstration data of close interactions between the robot and human beings through motion capture;
step S2, obtaining a plurality of human behavior pattern categories based on the demonstration data by using prior knowledge and clustering analysis;
step S3, segmenting and calibrating the demonstration data based on the plurality of human behavior pattern categories to obtain a plurality of groups of movement primitive sequences comprising human behavior pattern labels, constructing a hierarchical directed graph, and obtaining a robot behavior planner through training; and
step S4, constructing a dynamically consistent mapping model between a target trajectory and an action space, and realizing the planning and control of the humanoid behavior of the robot based on the dynamically consistent mapping model and the robot behavior planner.

2. The method for planning and controlling the humanoid behavior of the robot for close physical interactions according to claim 1, wherein the obtaining the plurality of human behavior pattern categories based on the demonstration data by using the prior knowledge and the clustering analysis in the step S2 comprises:
step S201, obtaining a clustering result based on the demonstration data through density-based clustering analysis; and
step S202: obtaining key attributes in human close physical interaction behaviors based on the clustering result and the prior knowledge obtained in advance, and constructing the plurality of human behavior pattern categories.

3. The method for planning and controlling the humanoid behavior of the robot for close physical interactions according to claim 2, wherein the step S202 comprises:
step S2021, obtaining the prior knowledge based on pre-acquired interdisciplinary literature;
step S2022, obtaining the key attributes in the human close physical interaction behavior based on the prior knowledge and the clustering result, the key attributes including tightness, hugging style, and bimanual cooperation style; and
step S2023, dividing hugging actions into the plurality of human behavior pattern categories based on the key attributes according to whether a chest is in contact, an extension direction of an upper arm and a stress direction of two arms.

4. The method for planning and controlling the humanoid behavior of the robot for close physical interactions according to claim 1, wherein the segmenting and calibrating the demonstration data based on the plurality of human behavior pattern categories in the step S3 comprises:
constructing a respective movement primitive for each of the plurality of human behavior pattern categories and segmenting and calibrating the demonstration data to obtain the plurality of groups of movement primitive sequences including human behavior pattern labels.

5. The method for planning and controlling the humanoid behavior of the robot for close physical interactions according to claim 1, wherein in the step S3, the hierarchical directed graph is constructed as:
$$G = ( S , V , R , P , σ )$$
wherein S represents a target hugging action, V is an AND node or an OR node in the directed graph, R represents a top-down production rule from a parent node α to its child node β, P represents a probability associated with each production rule, and σ is a behavior planning sequence defined by grammar.

6. The method for planning and controlling the humanoid behavior of the robot for close physical interactions according to claim 1, wherein the obtaining the robot behavior planner through the training in the step S3 comprises:
learning an association between a movement primitive space and a state space using a Q-learning rule in a temporal-difference manner by using a joint space of the two arms as a state space and with probability P between respective nodes as a learning object, and recovering a grammatical structure by automatic structural distillation according to posterior probability, so as to obtain the robot behavior planner.

7. The method for planning and controlling the humanoid behavior of the robot for close physical interactions according to claim 1, wherein the realizing the planning and control of the humanoid behavior of the robot based on the dynamically consistent mapping model and the robot behavior planner in the step S4 comprises:
generating a next movement primitive needed to complete the target hugging action by using the robot behavior planner for different joint states, and performing the target hugging action by using a respective mapping model.

8. The method for planning and controlling the humanoid behavior of the robot for close physical interactions according to claim 1, wherein the demonstration data comprises capture data for hugging behaviors and actions of multiple roles of participants in multiple age groups in multiple preset scenes, wherein the multiple preset scenes comprise social occasions, intimate relationships, emotional expression and motor functions, and the roles comprises an initiator and a receiver.

9. An electronic device, comprising one or more processors and a memory with one or more programs stored therein, the one or more programs comprising instructions for executing the method for planning and controlling the humanoid behavior of the robot for close physical interactions according to claim 1.

10. A computer-readable storage medium, comprising one or more programs for execution by one or more processors of an electronic device, the one or more programs comprising instructions for executing the method for planning and controlling the humanoid behavior of the robot for close physical interactions according to claim 1.
